(19) United States
(12) Patent Application Publication
(10) Pub. No.: US 2013/0187011 A1
(43) Pub. Date: Jul. 25, 2013

(54) APPARATUS FOR HANDLING TUBES AND ELECTRICAL LEADS

(71) Applicant: Ervin R. Rifenburg, Lodi, CA (US)

(72) Inventor: Ervin R. Rifenburg, Lodi, CA (US)

(21) Appl. No.: 13/354,191

(22) Filed: Jan. 19, 2012

(51) Int. Cl. F16L 3/22; H02G 15/02

(52) U.S. Cl. 248/68.1; 174/75 R

(57) ABSTRACT

A device is provided to easy the handling of lines provided to a patient in a hospital stetting. The device may handle single lines, or may handle a plurality of lines which may include one or more tubes and/or one or more electrical leads. The device provides tension to restrain parts of the lines and allows a patient to easily pull out a length of lines when needed. A plurality of lines is also provided having one or more tubes and one or more electrical leads that are joined together along a substantial length and which have connectors at each end.

### FIELD OF THE INVENTION

The present invention generally relates to an apparatus for handling tubes and electrical leads, and more particularly to an apparatus to that organizes lines provided to a patient in a hospital setting.

### DISCUSSION OF THE BACKGROUND

Hospital patents are often provided with tubes for providing fluids and electrical leads for monitoring the patent's status. Patients may, for example, be infused simultaneously with a plurality of different medications and fluids. Those medications and fluids are fed into the patient through tubes. Additionally, catheters are frequently utilized to monitor body functions. Patients are also often monitored, and there may be one or more electrical leads from the patient to various monitors. These tubes and leads have a tendency to become entangled, making it difficult for attending physicians and nurses to ascertain which line is being utilized for which purpose. This entanglement of the different lines is exceedingly common in the hospital room while the patient is recovering from a surgical operation. This entanglement is caused primarily by the patient moving around in either a conscious or unconscious condition. The management of so many lines may be problematic, especially when the patent moves in his bed, around his hospital room. It is not uncommon for lines to become tangled and/or to come loose from the patient, or for the lines to crimp or become otherwise abused.

There are line management device that have been developed, but these have limited usefulness and have their own problems. Thus, for example, there are devices that clamp or restrain a plurality of tubes and/or electrical leads. There are other devices that include mechanisms to provide some tension to individual electrical leads or tubes. Such devices allow for some degree of handling of the plurality of electrical leads and tubes provided to a patient in a hospital environment, but none of provide for the handling of the wire and tubes to accommodate the movement of a patient.

Thus there is a need in the art for an apparatus that can provide handling for a number of tubes and/or electrical leads in a hospital environment and that allows the patient to move without tangling or abusing the lines or patent connection. Such an apparatus should be compatible with current medical device/patient connection devices and techniques, should be easy for the patient and caregiver to use, and should be inexpensive.

### BRIEF SUMMARY OF THE INVENTION

The present invention overcomes the disadvantages of prior art by providing an apparatus that can handle and take up the slack on one or a plurality of electrical leads and/or tubes which may be connected to the patient.

In certain embodiments, an apparatus is provided that provides tension on one or more electrical leads and/or tubes. The apparatus may be placed, for example, near the patient; such on an IV pole stand, and includes clamps and a take-up reel to control the loose length of the lines.

In certain embodiments, an apparatus attachable to a pole for handling a plurality of lines is provided. The apparatus includes a frame attachable to the pole, where the frame includes a first clamp, and a second clamp; and a pulley, where the pulley is slidable along a length of the frame. The first clamp, second clamp and pulley are adapted to accept the plurality of lines. The apparatus is configured such that a length of the accepted plurality of lines may be restrained between the first clamp and the second clamp and may pass over the pulley, such that the pulley may provide tension to the accepted length of the plurality of lines.

In certain other embodimens, an appratus is provided that comprises a frame including a first clamp, and a second clamp; a pulley, where the pulley is slidable along a length of the frame; and a plurality of lines, where the plurality of lines includes one or more electrical leads and/or one or more tubes, where each of the leads and/or tubes have connectors at each end for connecting to medical instruments. The first clamp, second clamp and pulley are adapted to accept the plurality of lines. The appratus is configured such that a length of the accepted plurality of lines may be restrained between the first clamp and the second clamp and may pass over the pulley, such that the pulley may provide tension to the accepted length of the plurality of lines.

In yet other embodiments, an apparatus for handling a plurality of lines each having a connector at each end is provided. The apparatus includes a mechanism to provide tension to a plurality of lines including at least one clamp, where the clamp prevents the plurality of lines from being pulled into the mechanism and allows the plurality of lines to be pulled from the mechanism.

In other embodiments, a plurality of lines is provided comprising: one or more tubes each having a pair of ends each having a connector; and one or more electrical leads each having a pair of ends each having a connector. The tubes and electrical leads are joined together along a length of each the one or more tubes and the one or more electrical leads.

These features together with the various ancillary provisions and features which will become apparent to those skilled in the art from the following detailed description, are attained by the device for handling tubes and electrical leads of the present invention, preferred embodiments thereof being shown with reference to the accompanying drawings, by way of example only, wherein:

### BRIEF DESCRIPTION OF THE SEVERAL VIEWS OF THE DRAWING

FIG. 1 is a front view of a first embodiment festoon;

FIG. 2A is a detail view of the embodiment of FIG. 1 in a first configuration;

FIG. 2B is a side view 2B-2B of FIG. 1;

FIG. 2C is a detail view of the embodiment of FIG. 1 in a second configuration;

FIG. 3A is a top view 3A-3A of FIGS. 2A, 2B and 6A;

FIG. 3B is a top view 3B-3B of FIGS. 2A and 2B;

FIG. 3C is a top view 3C-3C of FIGS. 2A and 2B;

FIG. 4 is a sectional view 4-4 of FIG. 3A;

FIG. 5A is a front view of a second embodiment festoon;

FIG. 5B is an exploded view of the embodiment of FIG. 5A;

FIG. 6A is a top view 6A-6A of FIG. 5A;

FIG. 6B is a top view 6B-6B of FIG. 5A;

FIG. 6C is a top view 6C-6C of FIG. 5A;

FIGS. 7A-7G are section views of various embodiments of lines for use with any of the embodiments of the festoon, where FIG. 7A is a ribbon of tubes, FIG. 7B is a ribbon of electrical leads; FIG. 7C is a first embodiment of a ribbon of tubes and electrical leads; FIG. 7D is a second embodiment of a ribbon of tubes and electrical leads; FIG. 7E is a third embodiment of a ribbon of tubes and electrical leads passing over a spool; FIG. 7F is a fourth embodiment of a ribbon of tubes and electrical leads; and FIG. 7G is an embodiment illustrating separate tubes and/or electrical leads passing over a spool; and

FIG. 8 is an exploded view of several lines that may be use with, or constitute the present invention.

Reference symbols are used in the Figures to indicate certain components, aspects or features shown therein, with reference symbols common to more than one Figure indicating like components, aspects or features shown therein.

### DETAILED DESCRIPTION OF THE INVENTION

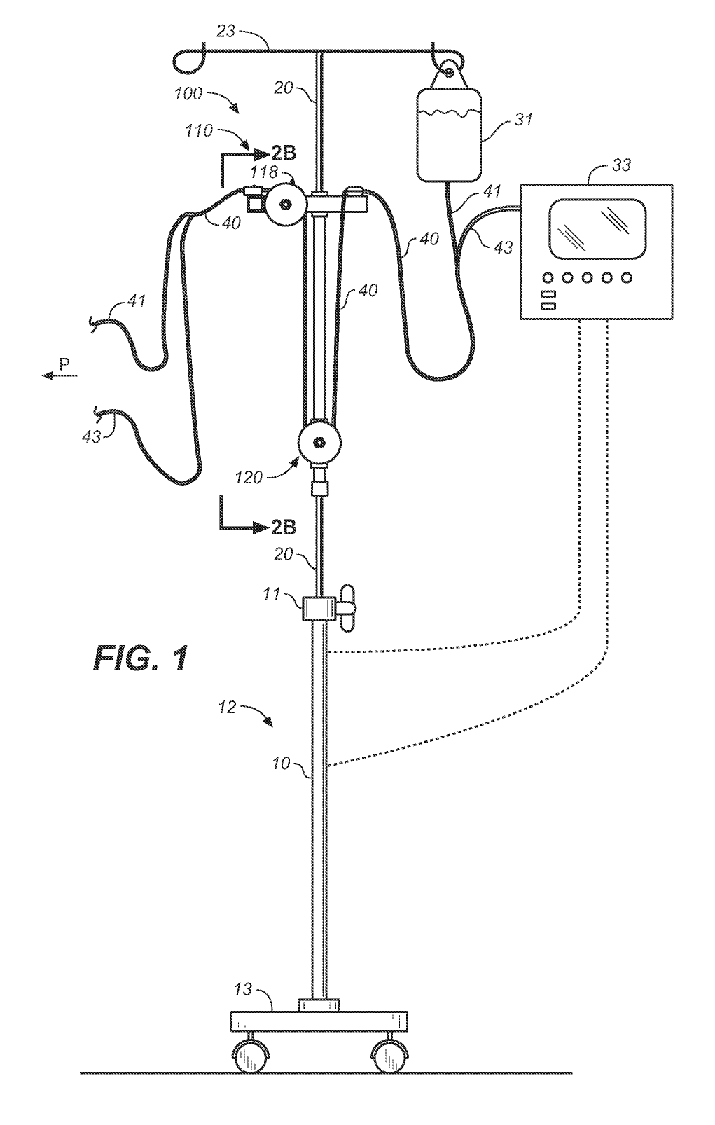

The present invention includes festoons that may be used, for example and without limitation, in a hospital setting. FIG. 1 is a front view of a first embodiment festoon 100. Festoon 100 may be used for handling one or more lines 40, which may include tube(s) 41 and/or wire(s) 43. To illustrate one possible use for festoon 100, the festoon is shown as being mounted on an IV pole stand 12, which may include a wheeled base 13, a first pole 10, a second pole 20 that is inserted into the center of pole 10, an IV bag support member 23 at the top of pole 20, and a clamping mechanism 11 to adjust the height of the IV bag support member. Festoon 100 includes an upper portion 110 and a lower portion 110 through which line(s) 40 pass, and which allow a patient to move with a minimal amount of tangling of the line(s).

FIG. 1 also shows an IV bag 31 which may be connected to tube 41 and a medical monitor which may be mounted on IV pole stand 12 and which has electrical leads 43. The one or more lines 40 pass through festoon 100 and have ends that are attached to patient P (not shown). One or more of line(s) 40 may optionally be free at one or more end—that is, not be connected to a patient and/or an IV bag or monitor.

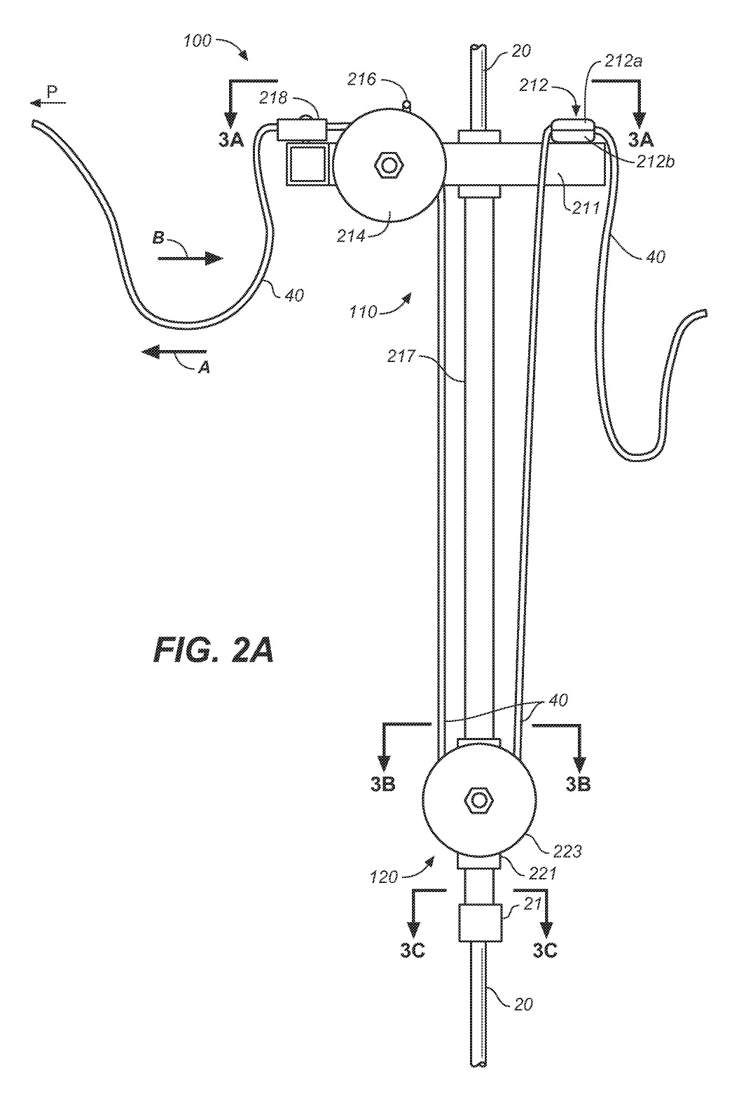

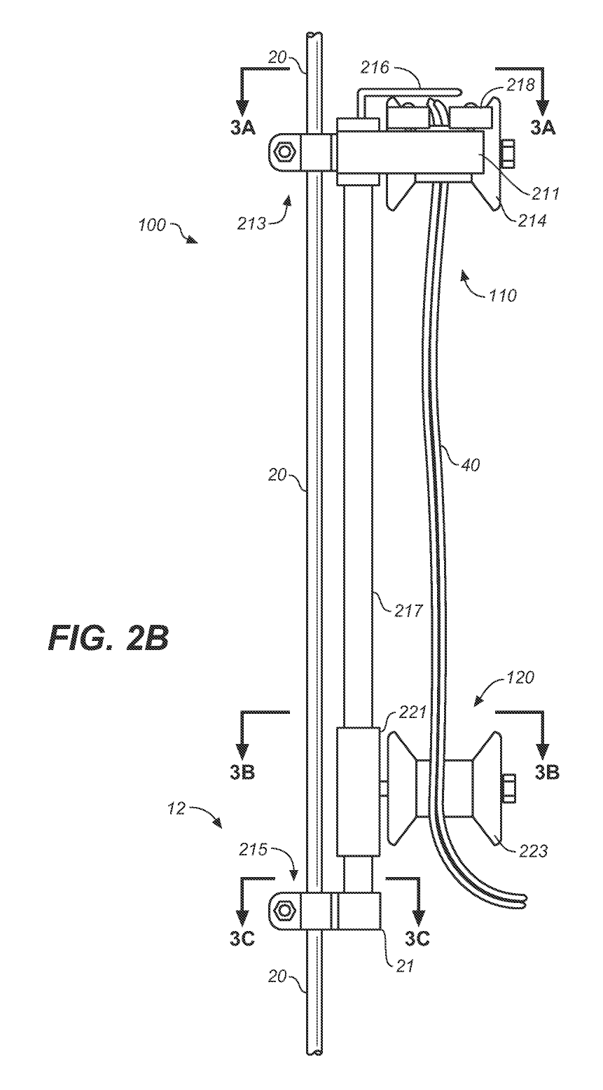

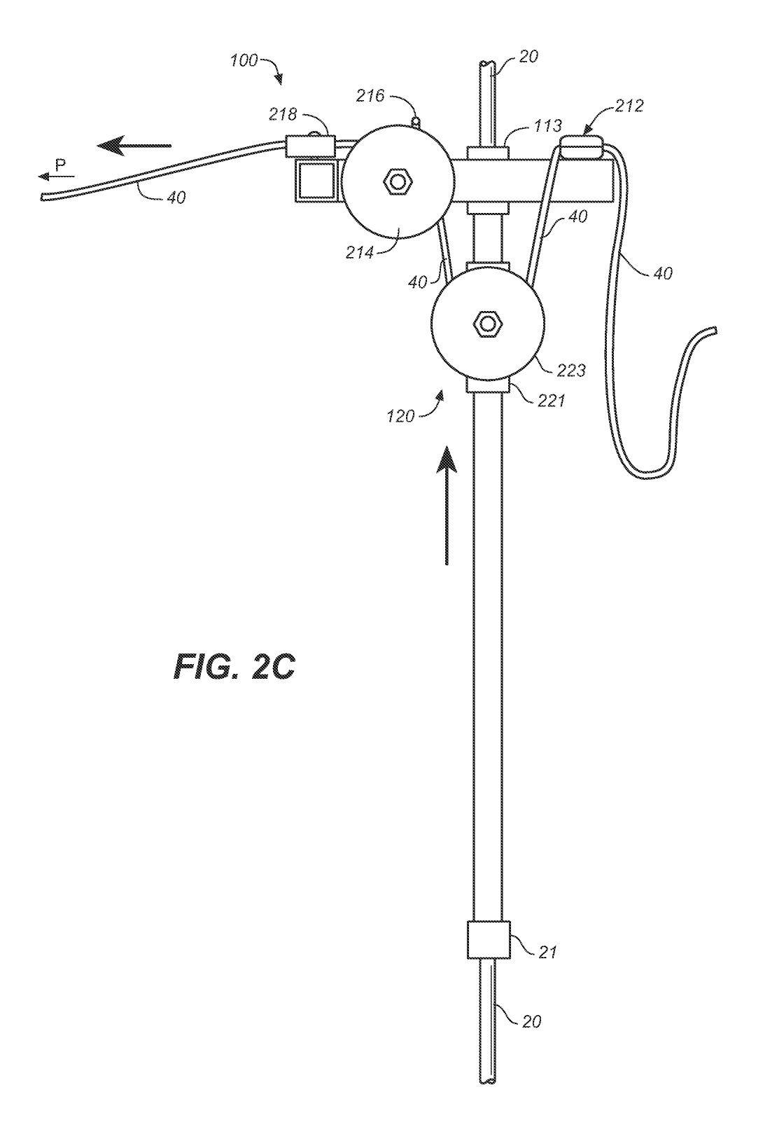

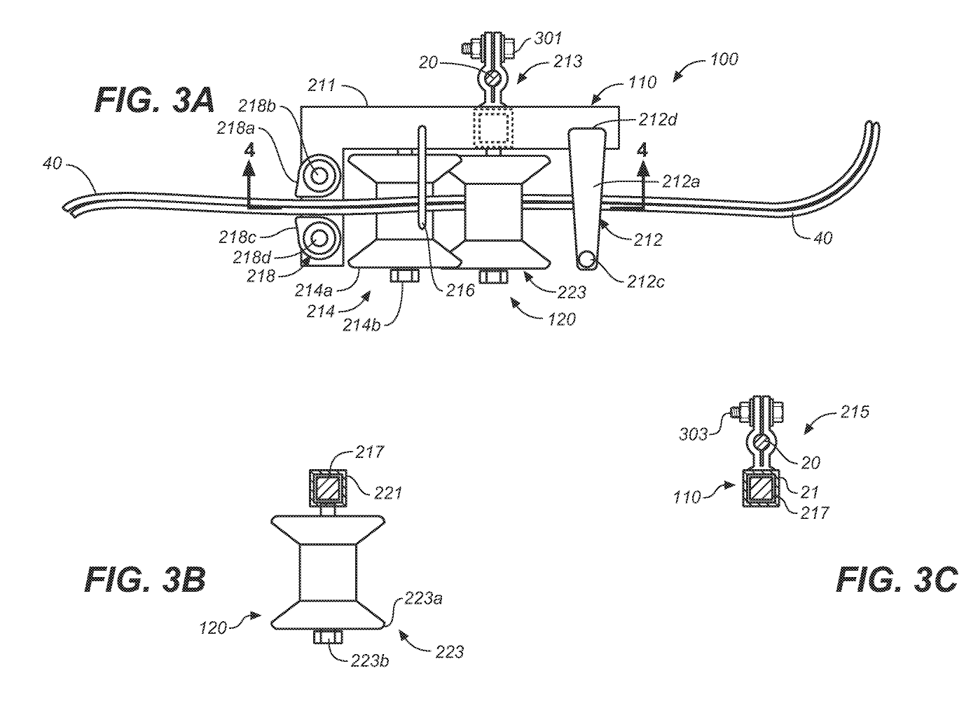

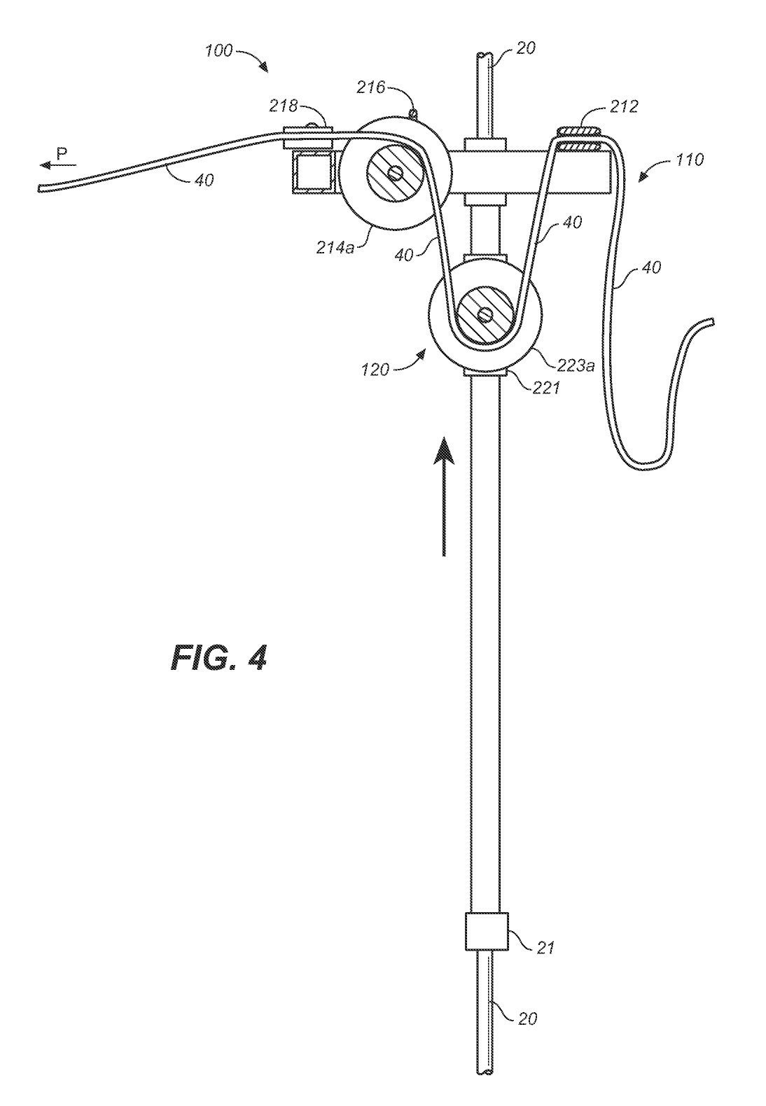

Festoon 100 is shown in more detail in: FIG. 2A as a detail view of the embodiment of FIG. 1 in a first configuration; FIG. 2B as a side view 2A-2A of FIG. 1; FIG. 2C as a detail view of the embodiment of FIG. 1 in a second configuration; FIG. 3A in a top view 3A-3A of FIGS. 2A and 2B; FIG. 3B as a top view 3B-3B of FIGS. 2A and 2B; FIG. 3C as a top view 3C-3C of FIGS. 2A and 2B; and FIG. 4 as a sectional view 4-4 of FIG. 3A.

With reference to FIGS. 2A and 2B, festoon 100 is shown as including upper portion 110 which may be affixed to pole 20, and lower portion 120 that is movable relative to pole 20. Specifically, upper portion 110 includes a support 211, a bar 217, and brackets 213 and 215 for mounting to pole 20, a first clamp 212, a first pulley 214 and an associated bar 216, and a second clamp 218 attached to the support. Lower portion 120 includes a second pulley 223 attached to a collar 221 which may slide along pole 20. With reference to FIGS. 2B, 3A, and 3C, a nut 301 is provided in clamp 213 and a nut 303 is provided to clamp 215 to attach upper portion 110 to pole 20. With reference to FIGS. 3B, collar 221 fits over and is slidable along bar 217. Collar 211 and bar 217 have circular cross-sectional shape, or may have matching cross-sectional shapes to prevent rotation of the collar on the bar—that is, not have circular cross-section. The cross-sectional shapes may be square, as illustrated most clearly in FIG. 3B, or may be rectangular, oval, triangular, or have some other non-circular shape. A stop 21 may optionally be provided to prevent second portion 120 from sliding too far down pole 20.

FIGS. 2A, 2B, and 3A show that clamps 212 and 218 and pulleys 214 and 223 are aligned to allow line(s) 40 to easily pass over and through the various components. Thus, line(s) 40 pass, from the IV bag or monitor, through clamp 212, around pulley 223 and 214, through clamp 218, and to the patient. In addition, FIG. 2C shows that lower portion 120 may move relative to upper portion 110 and that, in conjunction with clamps 212 and 218, festoon 100 may accommodate slack in line(s) 40 by maintaining tension on the lines. Pulleys 214 and 223 and clamps 212 and 218 are thus arranged so that line(s) 40 from patient P pass through clamp 218, over pulley 214, around pulley 223, and through clamp 223 before proceeding, for example and without limitation, to IV bags or monitors. In one embodiment, clamps 212 and 218 provide enough force of line(s) 40 to prevent them from moving without damaging the lines or preventing fluid from flowing through any tube 41.

Upper portion 110 and lower portion 120 are shown in greater detail in FIGS. 3A, 3B, and 3C. As shown in FIG. 3A, clamp 212 may, for example and without limitation, include a lower portion 212b attached to support 211, and an upper portion 212a connected lower portion 212b with a hinge 212d. A clasp 212c at the end opposite hinge 212d allows clamp 212 to open to accept line(s) 40 and retain the upper portion 212c to restrain the motion of the line(s).

In one embodiment, clamp 218 is a one-way device that preferentially allows one to pull line(s) 40 away from festoon 100. Thus, for example, clamp 218 may include a first cam 218a mounted to support 211 at an axle 218b, and a second cam 218c mounted to the support at an axle 218d, as shown in FIG. 3. This configuration of clamp 218 allows line(s) 40 to be pulled away from festoon 100, while tightening up on the line(s) when they are pulled into the festoon.

In one embodiment, pulley 214 includes a spool 214a mounted to support 211 by an axle 214b, as shown in FIG. 3A. Bar 216 projects part way across spool 214a, and assists in keeping line(s) 40 within the spool. In another embodiment pulley 223 includes a spool 223a mounted to collar 221 by an axle 223b, as shown in FIG. 3B.

The operation of festoon 100 is illustrated with reference to FIGS. 2A, 2B and 4. Tube(s) 40 as shown as being restrained by clamps 212 and 218, and passing over spools 214a and 223a. In general, tension is provided to line(s) 40 by clamping the line(s) between clamps 212 and 218, and by the weight of lower portion 120 pulling down on the line(s). Specifically, the arrangement of clamps 212 and 218 prevents line(s) 40 from moving inwards towards lower portion 120, providing tension on the line(s). In alternative embodiments, an additional weight may be provided to lower portion 120, and/or a spring may be attached between lower portion and upper portion 110 to provide additional tension to line(s) 40.

As shown in FIG. 2B, line(s) 40 may be pulled toward patient P, in the direction indicated by arrow A, causing clamp 218 to open to allow movement of the line(s) and upwards movement of lower portion 120, to a configuration similar to that of FIG. 2C. Lower portion 120 will stay in this position until clamp 218 is released, causing excess slack in line(s) to be taken in, as indicated by arrow B, by the downward movement of lower portion 120, reverting festoon 100 to the configuration of FIG. 2A.

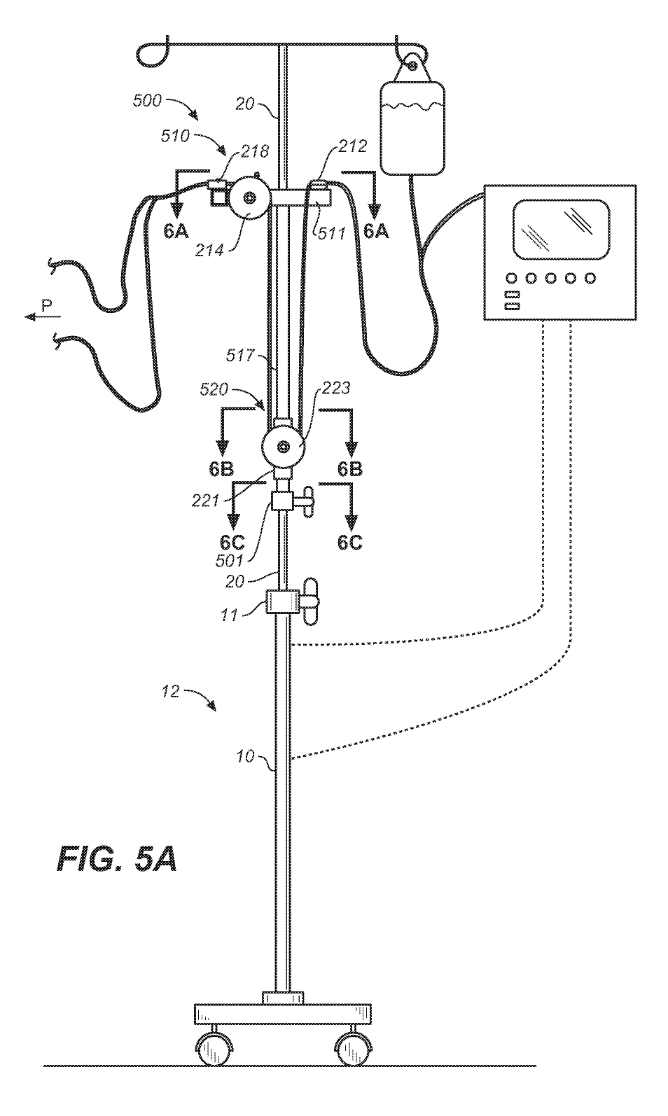

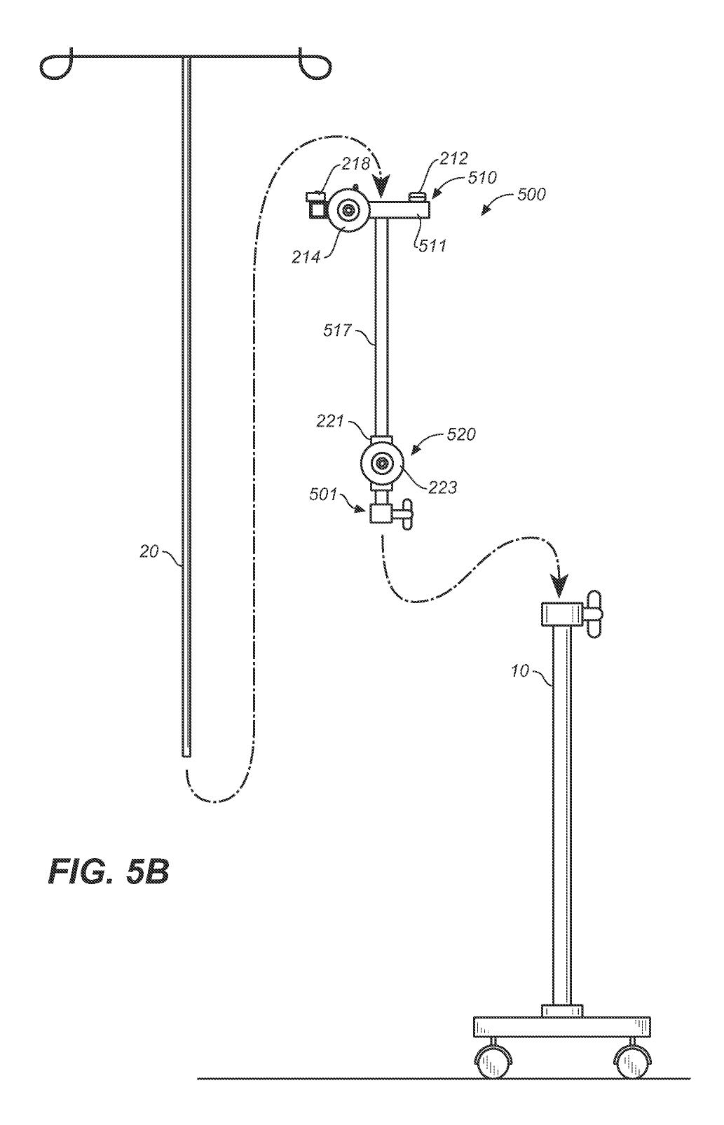

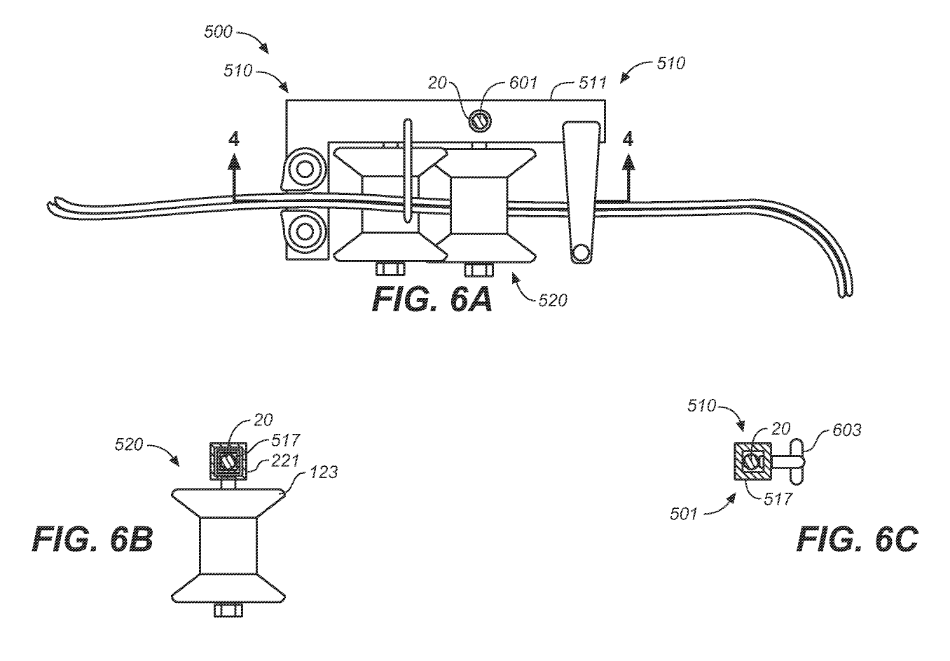

A second embodiment festoon 500 is shown in more detail in: FIG. 5A as a front view of a second embodiment festoon; FIG. 5B as an exploded view of the embodiment of FIG. 5A; FIG. 6A as a top view 6A-6A of FIG. 5A; FIG. 6B as a top view 6B-6B of FIG. 5A; FIG. 6C as a top view 6C-6C of FIG. 5A; and in FIG. 4 as a sectional view 4-4 of FIG. 6A. Festoon 500 may be generally similar to festoon 100 in function and in construction, except as further detailed below. Where possible, similar elements are identified with identical reference numerals in the depiction of festoon 100 and 500.

Festoon 500 is similar to festoon 100, where an upper portion 510 and a lower portion 520, generally similar to portions 110 and 120, respectively. Upper portion 510 includes a tube 517 that, as shown in FIG. 5B, is adapted to accept pole 20 and to which is mounted a support 511, generally similar to support 211, which has a hole 601 to accept pole 20. Tube 517 also has a clamp 501 with a set screw 603 for clamping upper portion 510 to pole 20. As shown in FIG. 6B, lower portion 520 includes collar 221 that slides on the outer surface of tube 517.

As illustrated in FIG. 5B, festoon 500 may be assembled on IV pole stand 12 by removing pole 20, placing the pole through the tube, and tightening set screw 603. The operation of festoon 500 in managing line(s) 40 is similar to that of festoon 100, as described above.

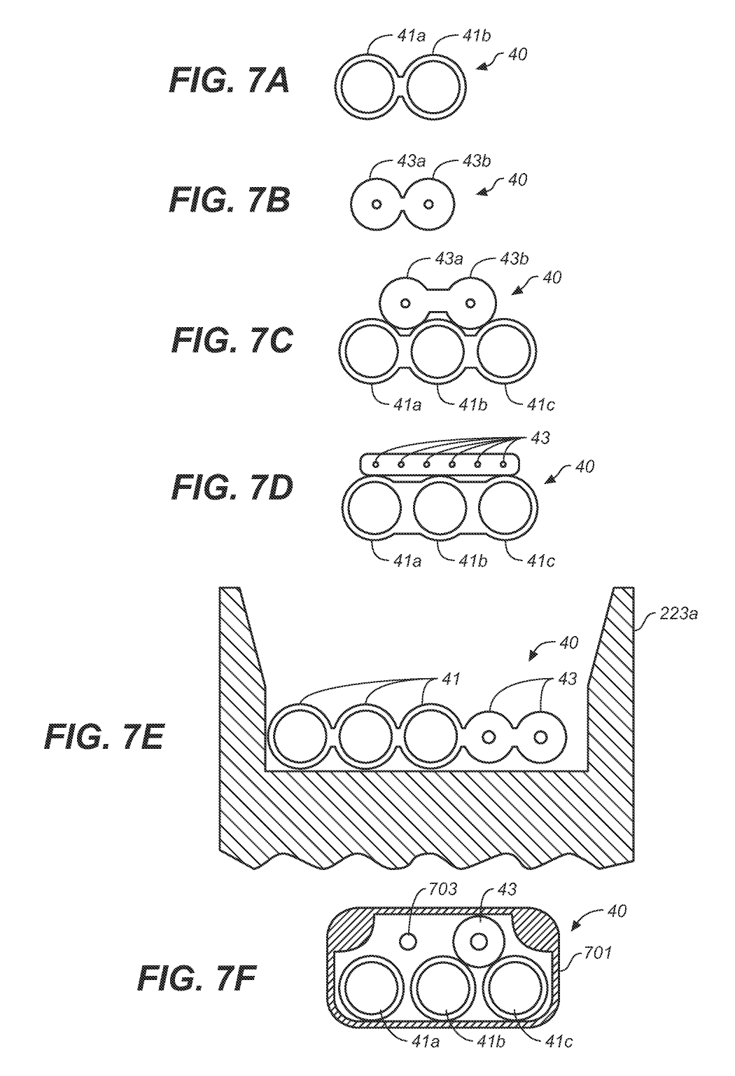

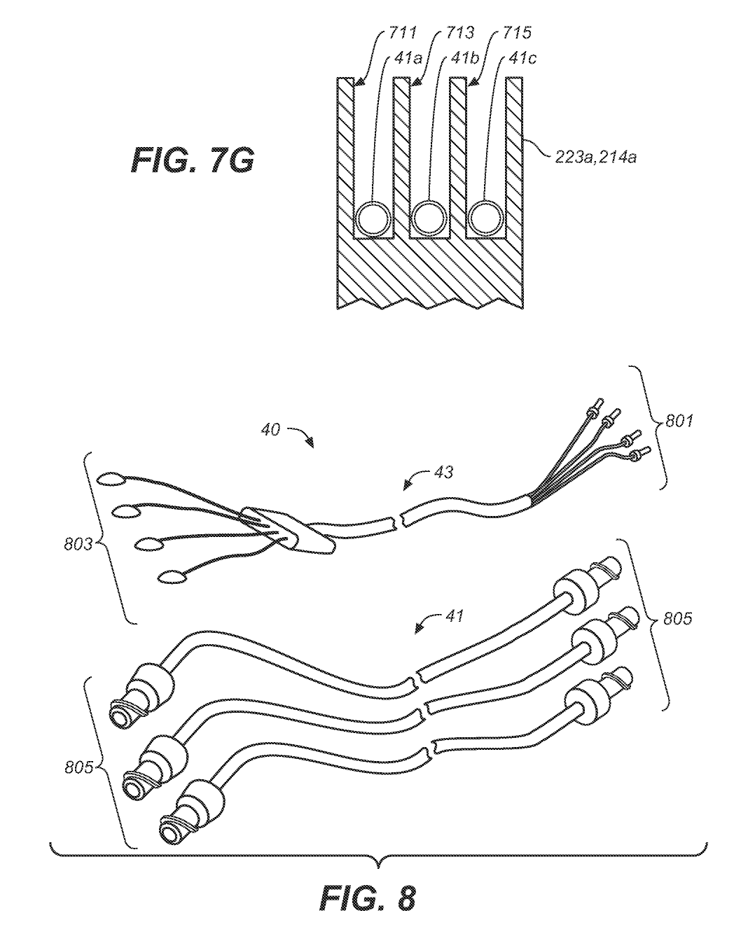

FIGS. 7A, 7B, 7C, 7D, 7D, 7F, and 7G are section views of various embodiments of line(s) 40 which may be used by themselves, or may be used with any one of festoon 100 or 500. In general, line(s) may be one or more tube and/or one or more wire that are joined, fused, bonded, and/or encased along a substantial length to form a ribbon. Line(s) 40 of FIG. 7A is a ribbon of tubes 41a and 41b. Tubes 41a and 41b may be for example IV tubes that are joined along their length by fusion. Line(s) 40 of FIG. 7B is a ribbon of electrical leads 43a and 43b. Electrical leads 41a and 41b may be for example hart monitor leads or blood oxygen monitor leads that are joined along their length by fusion or adhesive. Line(s) 40 of FIG. 7C is a first embodiment ribbon of tubes 41a, 41b, and 41c and electrical leads 43a and 43b. Tubes 41a, 41b, and 41c and electrical leads 43a and 43b may be joined along their length by fusion or adhesive methods. Line(s) 40 of FIG. 7D is a second embodiment ribbon of tubes 41a, 41b and 41c and electrical leads 43, where electrical leads 43 are a preformed wire ribbon cable. FIG. 7E illustrates a line(s) 40 as a third embodiment ribbon of tubes and electrical leads passing over a spool 223a. Line(s) 40 of FIG. 7F is a fourth embodiment of line(s), where individual tubes 41a, 41b, and 41c and wire 43 are encased in a sheath 701. An optional strand 703 may be provided for strain relief. Sheath 701 may be, for example and without limitation, hart monitor leads or wires in cable form.

In an alternative embodiment, the festoon may be configures to handle individual tubes and/or electrical leads. FIG. 7G is an embodiment illustrating a spool 214a, 223a having slots 711, 713, and 715, into which separate tubes and/or electrical leads may be placed.

FIG. 8 is an exploded view of line(s) 40 indicating that one embodiment provides appropriate connectors at the end of each line. Line(s) 40 that may be use with, or constitute the present invention.

Line(s) 40 are shown as including illustrative examples of tubes 41 and electrical leads 43. Thus electrical leads 43 may include connectors 801 for connecting to medical instruments and/or pads 803 for connecting to the patient. Tubes 41 may include connectors 805 for connecting to IV bags or lines into the patient. A wide variety of connector types are known in the field. Any of these connectors may be incorporated into line(s) 40.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner, as would be apparent to one of ordinary skill in the art from this disclosure, in one or more embodiments.

Similarly, it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

I Claim:

1. An apparatus attachable to a pole for handling a plurality of lines, said apparatus comprising:
a frame attachable to the pole, where said frame includes
a first clamp, and
a second clamp; and
a pulley, where said pulley is slidable along a length of said frame,
where said first clamp, said second clamp and said pulley are adapted to accept the plurality of lines,
such that a length of the accepted plurality of lines may be restrained between said first clamp and said second clamp and may pass over said pulley, such that the pulley may provide tension to the accepted length of the plurality of lines.

2. The apparatus of claim 1, wherein said first clamp includes a mechanism to allow accepted plurality of lines to be pulled in a direction away from said first clamp, said second clamp and said pulley.

3. The apparatus of claim 1, wherein said pulley is a first pulley, and where said frame further includes a second pulley to accept the plurality of lines and to guide said plurality of lines between said first clamp and said first pulley.

4. The apparatus of claim 1, further including a mechanism to attach said frame to the outside of said pole.

5. The apparatus of claim 1, wherein said frame includes a tubular portion adapted to accept the pole.

6. The apparatus of claim 1, wherein said plurality of lines includes at least one tube and at least one electrical lead.

7. The apparatus of claim 1, wherein said pole is part of an IV pole stand.

8. An apparatus attachable comprising:
a frame including
a first clamp, and
a second clamp;
a pulley, where said pulley is slidable along a length of said frame; and
a plurality of lines, where said plurality of lines includes one or more electrical leads and/or one or more tubes, where each of said leads and/or tubes have connectors at each end for connecting to medical instruments,
where said first clamp, said second clamp and said pulley are adapted to accept the plurality of lines,
such that a length of the accepted plurality of lines may be restrained between said first clamp and said second clamp and may pass over said pulley, such that the pulley may provide tension to the accepted length of the plurality of lines.

9. The apparatus of claim 8, wherein said first clamp includes a mechanism to allow accepted plurality of lines to be pulled in a direction away from said first clamp, said second clamp and said pulley.

10. The apparatus of claim 8, wherein said pulley is a first pulley, and where said frame further includes a second pulley to accept the plurality of lines and to guide said plurality of lines between said first clamp and said first pulley.

11. The apparatus of claim 8, further including a mechanism to attach said frame to the outside of a pole.

12. The apparatus of claim 8, wherein said frame includes a tubular portion adapted to accept a pole.

13. The apparatus of claim 1, wherein said frame includes IV pole stand.

14. An apparatus for handling a plurality of lines each having a connector at each end, said apparatus comprising:
a mechanism to provide tension to a plurality of lines including at least one clamp,
where said clamp prevents the plurality of lines from being pulled into the mechanism and allows the plurality of lines to be pulled from said mechanism.

15. The apparatus of claim 14, wherein said plurality of lines includes at least one tube and at least one electrical lead.

16. The apparatus of claim 14, where said at least one clamp is a pair of clamps, and where said mechanism to provide tension includes a pulley configured to pull the plurality of lines away from said pair of clamps.

17. A plurality of lines comprising:
one or more tubes each having a pair of ends each having a connector; and
one or more electrical leads each having a pair of ends each having a connector,
where said one or more tubes and said one or more electrical leads are joined together along a length of each said one or more tubes and said one or more electrical leads.

18. The plurality of lines of claim 17, where said tubes and said electrical leads are connectable to medical devices.
